(19) United States
(12) Patent Application Publication
(10) Pub. No.: US 2018/0263184 A1
(43) Pub. Date: Sep. 20, 2018

(54) Weed Trimmer Stabilizer System

(71) Applicant: James Cline, Lees Summit, MO (US)

(72) Inventor: James Cline, Lees Summit, MO (US)

(21) Appl. No.: 15/459,356

(22) Filed: Mar. 15, 2017

(51) Int. Cl. A01D 34/86; A01D 34/416

(52) U.S. Cl. CPC A01D 34/86; A01D 34/416

(57) ABSTRACT

A weed trimmer stabilizer system for retaining a weed trimmer at a constant height includes a weed trimmer that may be manipulated for trimming plants. The weed trimmer has a spool and the spool has a bottom surface. A stabilizer is coupled to and extends downwardly from the bottom surface of the spool. The stabilizer abuts ground thereby facilitating the spool to be spaced and retained a selected distance from the ground.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

[symbol]

### (2) Description of Related Art Including Information Disclosed Under 37 CFR 1.97 and 1.98

The disclosure and prior art relates to stabilizer devices and more particularly pertains to a new stabilizer device for retaining a weed trimmer at a constant height.

### BRIEF SUMMARY OF THE INVENTION

An embodiment of the disclosure meets the needs presented above by generally comprising a weed trimmer that may be manipulated for trimming plants. The weed trimmer has a spool and the spool has a bottom surface. A stabilizer is coupled to and extends downwardly from the bottom surface of the spool. The stabilizer abuts ground thereby facilitating the spool to be spaced and retained a selected distance from the ground.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a weed trimmer stabilizer system according to an embodiment of the disclosure.

FIG. 2 is a bottom view of an embodiment of the disclosure.

FIG. 3 is a back view of an embodiment of the disclosure.

FIG. 4 is a perspective in-use view of an embodiment of the disclosure.

### DETAILED DESCRIPTION OF THE INVENTION

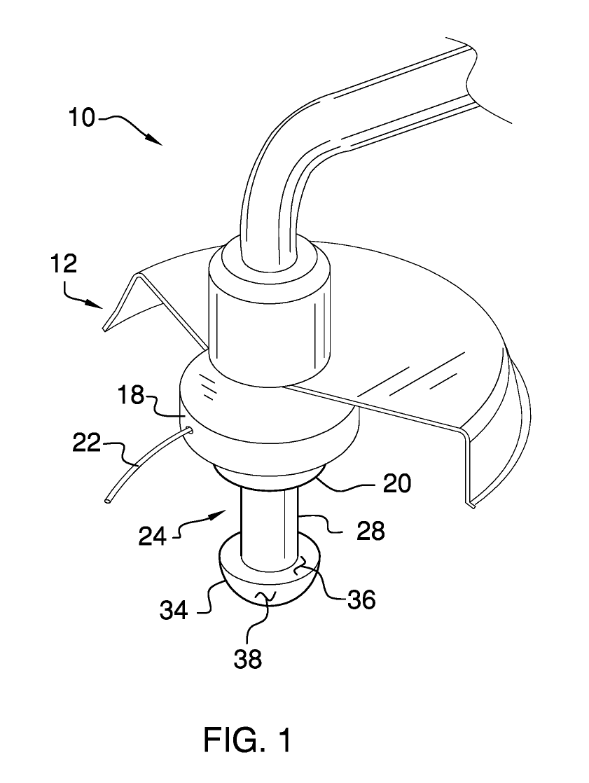

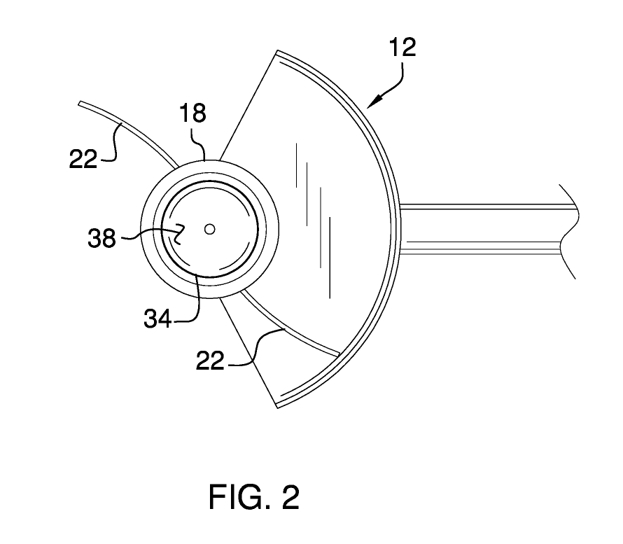

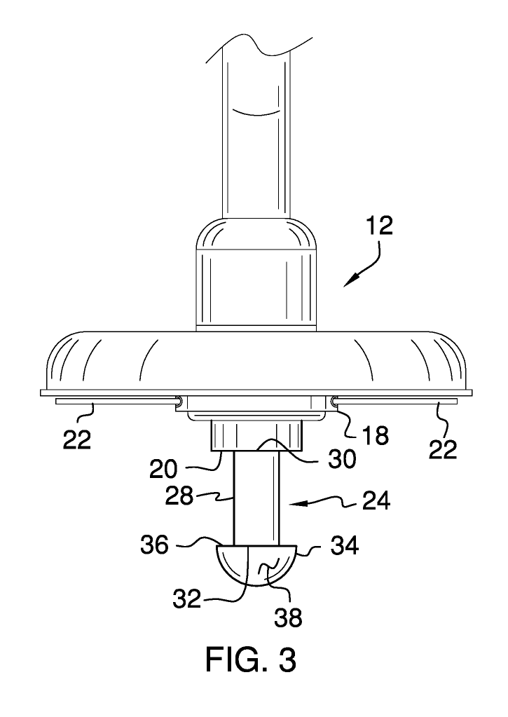

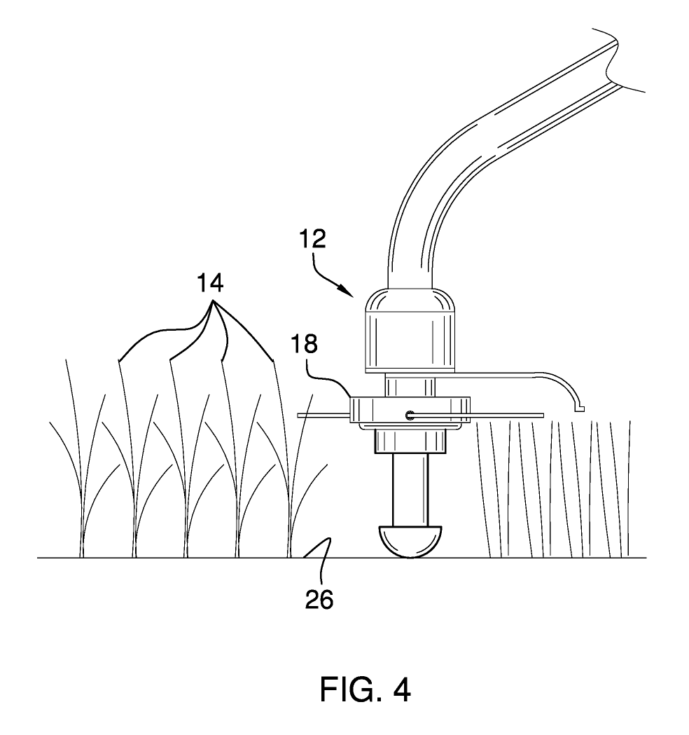

With reference now to the drawings, and in particular to FIGS. 1 through 4 thereof, a new stabilizer device embodying the principles and concepts of an embodiment of the disclosure and generally designated by the reference numeral 10 will be described.

As best illustrated in FIGS. 1 through 4, the weed trimmer 12 stabilizer 24 system 10 generally comprises a weed trimmer 12 that is selectively manipulated for trimming plants 14. The weed trimmer 12 has a spool 18 and the spool 18 has a bottom surface 20. The weed trimmer 12 may be a powered weed trimmer 12 of any conventional design to include, but not be limited to, gas weed trimmers and electric weed trimmers. Moreover, the spool 18 rotates about a vertical axis when the weed trimmer 12 is turned on. At least one trimming line 22 extends laterally away from the spool 18 to trim the plants 14 when the weed trimmer 12 is turned on.

A stabilizer 24 is provided and the stabilizer 24 is coupled to and extends downwardly from the bottom surface 20 of the spool 18. The stabilizer 24 abuts ground 26 when the weed trimmer 12 is manipulated. In this way the spool 18 is spaced and retained a selected distance from the ground 26; this facilitates the at least one trimming line 22 to be maintained at a consistent height when the plants 14 are trimmed.

The stabilizer 24 comprises a shaft 28 that has a first end 30 and a second end 32. The first end 30 is coupled to the bottom surface 20 of the spool 18 and the shaft 28 is centrally positioned on the bottom surface 20. The shaft 28 may be a unitary structure with respect to the spool 18 and the shaft 28 may be retrofitted onto an existing spool 18. The shaft 28 may be coupled to the spool 18 through any mechanical means such as fasteners or the like.

The stabilizer 24 includes a dome 34 that has a first surface 36 and a second surface 38. The first surface 36 is flattened and the first surface 36 is coupled to the second end 32 of the shaft 28. Moreover, the shaft 28 is centrally positioned on the first surface 36. The second surface 38 of the dome 34 frictionally engages the ground 26 when the weed trimmer 12 is manipulated for trimming the plants 14. The second surface 38 is concavely acruate with respect to the first surface 36 to reduce friction between the second surface 38 and the ground 26.

In use, the weed trimmer 12 is manipulated for the purposes of trimming plants 14. The second surface 38 of the dome 34 abuts the ground 26 when the weed trimmer 12 is used. In this way the trimming line 22 is spaced and retained a selected distance from the ground 26. Thus, the trimming line 22 trims the plants 14 at a consistent height. Additionally, the stabilizer 24 facilitates the trimming line 22 to cut the plants 14 at a height to match contours of uneven ground 26. In this way the trimming line 22 is inhibited from scalping the ground 26 when the weed trimmer 12 is moved across a depression in the ground 26.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. A weed trimmer stabilizer system comprising:
a weed trimmer, said weed trimmer having a spool, said spool having a bottom surface, said weed trimmer having a cutting line extending from said spool wherein said weed trimmer is configured for trimming the plants; and
a stabilizer being coupled to and extending downwardly from said bottom surface of said spool wherein said stabilizer is configured to abut ground thereby facilitating said spool to be spaced and retained a selected distance from the ground, said stabilizer comprising a shaft having a first end and a second end, said shaft being a unitary extension from said spool having said first end being integrally coupled to said bottom surface of said spool, said shaft being centrally positioned on said bottom surface.

2. (canceled)

3. The system according to claim 1, wherein said stabilizer comprises
a dome having a first surface and a second surface, said first surface being flattened, said first surface being coupled to said second end of said shaft having said shaft being centrally positioned on said first surface wherein said second surface of said dome is configured to frictionally engage the ground.

4. The system according to claim 3, wherein said second surface is concavely arcuate with respect to said first surface wherein said second surface is configured to reduce friction between said second surface and the ground.

5. A weed trimmer stabilizer system comprising:
a weed trimmer, said weed trimmer having a spool, said spool having a bottom surface, said weed trimmer having a cutting line extending from said spool wherein said weed trimmer is configured for trimming the plants; and
a stabilizer being coupled to and extending downwardly from said bottom surface of said spool wherein said stabilizer is configured to abut ground thereby facilitating said spool to be spaced and retained a selected distance from the ground, said stabilizer comprising:
a shaft having a first end and a second end, said shaft being a unitary extension from said spool having said first end being coupled to said bottom surface of said spool, said shaft being centrally positioned on said bottom surface, and
a dome having a first surface and a second surface, said first surface being flattened, said first surface being coupled to said second end of said shaft having said shaft being centrally positioned on said first surface wherein said second surface of said dome is configured to frictionally engage the ground, said second surface being concavely acruate with respect to said first surface wherein said second surface is configured to reduce friction between said second surface and the ground.
